(19) United States
(12) Patent Application Publication
(10) Pub. No.: US 2011/0106623 A1
(43) Pub. Date: May 5, 2011

(54) SYSTEM AND METHOD FOR SEARCHING FOR A PROFESSIONAL SERVICE PROVIDER

(76) Inventor: Ronald Keith Perkins, Queen Creek, AZ (US)

(21) Appl. No.: 12/608,274

(22) Filed: Oct. 29, 2009

(51) Int. Cl. G06Q 30/00; G06Q 40/00; G06Q 50/00; G06Q 20/00

(52) U.S. Cl. 705/14.58; 705/26.7

(57) ABSTRACT

The present invention relates to a method for allowing consumers to search for a provider of a specific type of professional service, typically legal. A method configured according to an embodiment of the present invention may involve supplying a location indicator in which to locate a service provider; supplying an area of the specific type of service which the user is interested in; being supplied a list of service providers working in the area of the specific type of service which the user is interested in and in or near the location indicator; being supplied a list of flat rate or fee prices for the service providers on the list and being supplied a list of the status of the service providers' participation in a charitable program. This method may be utilized by a web based system.

### BACKGROUND OF THE INVENTION

1. Technical Field

This invention relates to a system and method to motivate professionals to voluntarily increase fulfillment of their professional ethical obligations through use of an online professional service directory that combines incentives rewarding use by both the public and the professionals.

2. Background Art

Many professionals are governed by ethical obligations within their respective trades. For example, all lawyers are governed by ethical rules of their State Bar. Virtually every state has a bar foundation that serves many purposes relative to the administration of lawyers in that particular state. In addition, bar foundations generally provide services including: organizing the providing of free legal services to those who cannot afford them, receiving and resolving complaints against attorneys, sponsoring or approving Continuing Legal Education, setting attorney guidelines and rules of ethics, managing attorney registration, giving the public lawyer referrals, overseeing attorney trust accounts commonly referred to as IOLTA accounts (Interest On Lawyer Trust Accounts), and providing funding to several of the most promising and critical non profit legal service providers in their state. A common ethical obligation for lawyers is to provide fifty pro bono (without charge) legal service hours to individuals of limited financial means—or make a financially equivalent donation (commonly set at $500.00) to their State Bar Foundation or another qualified non profit legal service provider. As there are over one million practicing lawyers in the United States, the potential exists for lawyers nationwide to collectively be donating (or providing services valued at) as much as $500,000,000.00 annually to Bar Foundations or other qualified non profit legal service providers who help individuals of limited financial means.

Unfortunately, too many professionals have not fulfilled these ethical obligations. The problem is simple: many of these professional obligations are not mandatory or enforced. A long history (and likely future) without consequences or penalties for failing to fulfill ethical obligations combined with a perceived lack of any other real incentive has unfortunately created a deeply imbedded lackadaisical culture and apathetic attitude among professionals concerning the importance and effort they are willing to place on fulfilling these ethical obligations. Sadly, far too few professionals voluntarily comply. The natural result is that both the public and non profit service providers are consistently denied millions of dollars annually worth of much needed assistance which professionals are obligated, but fail, to provide.

Of course, the governing trade associations have noticed and are well aware that millions of dollars are being lost annually—but they have been unable to create a simple but powerful system or method to consistently solve the problem. For example, over the past several decades, State Bar Foundations throughout the United States have tried many different methods with only minor limited success to encourage professionals (such as lawyers) to voluntarily fulfill their ethical obligations. To better understand the gravity and pervasiveness of the problem, consider that in 2008, only one third of Arizona lawyers reported that they fulfilled this ethical obligation. It should be noted that these numbers may actually be too high as they are self reported, which tends to inherently be too generous. Perhaps more accurate data shows an even bleaker picture, indicating that Arizona lawyers donated to their governing organization an amount that would be equivalent to only 2% of Arizona lawyers fulfilling this ethical obligation. Even when the economy was at its height, voluntary fulfillment of these ethical obligations remained low. Economic recessions exacerbate the problem even more—at the very time when the public desperately needs these professionals to fulfill their ethical obligations the most. Thus, there exists an unhealthy negative converse relationship between the public's increased need during economic recessions for professionals to fulfill these ethical obligations to provide pro bono services, at the very time when professionals are themselves feeling strained by economic difficulties causing them to be even less likely to provide free pro bono services to the public. It is precisely for this reason, that this difficult problem has continued to exist in every state throughout the United States for many, many years. The problem is complex. Such a widespread problem, over such a long period of time, costing loss opportunity of millions of dollars each year—makes it obvious that a viable system or method to resolve this problem is not yet known within the market at this time.

Like most other professionals, the legal field has also been severely hurt by the present recession. When an attorney receives money in advance from a client they are required to place that money into an IOLTA account. The interest from the account goes to the State Bar Foundation which uses the funds to provide legal services to those living in poverty and to strengthen the judicial system. The recent downturn in the economy has caused a perfect storm for state bar foundations. During hard economic times when the number of people in need of legal services who qualify as poor is increasing, fewer clients place money in lawyers trust accounts at the same time that interest rates are decreasing causing attorney IOLTA accounts to be down a reported twenty five percent. This has caused a decrease as much as sixty five percent in funding of legal services for the poor and caused layoffs at bar foundations.

In the last few years, the public has become reliant upon online price shopping for a wide variety of goods and services. However, in order to effectively compare prices, the actual price must be certain. No one can compare a price that is “unknown” until well after the item or service is finally purchased. This is so critical, that many industries (such as mortgages, banks, and cars) are now regulated by the government to ensure that critical information, such as prices, are reported in a way that is fair and can be reasonably compared by the general public.

However, many professionals still do not disclose the actual prices for their services until long after the client has paid substantially. Many professionals have traditionally charged “by the hour” for their services. Perhaps the most obvious is the legal industry. It is a century old business tradition for lawyers to require a client to provide them an up front retainer that the lawyer puts into his trust account, and then deducts from it his hourly rate as work progresses along. For several reasons, the public often feels that this system only works in the lawyers' favor, as it appears to provide an inherent financial incentive for the lawyer to take longer to do the work than may be necessary. Additionally, the billable hour system destroys competition since information about the actual price is withheld from the public, causing potential clients to be completely unable to compare different lawyers and their actual prices. This can be a big deterrent for potential customers, because the general population has a finite amount of funds to use. Shopping for a service provider can be very time consuming Existing online professional service referral companies fail to adequately define the service with sufficient detail to permit a professional to include a flat fee for that specific service. Often a potential customer has to visit multiple locations and spend time meeting with multiple service providers. This costs both the potential customer and the service provider significant time. Also, many potential customers will simply forgo the service in order to avoid the hassle. Recent public opinion surveys conclude that a significant portion of the public would greatly prefer to hire an attorney on a flat fee, rather than pay an attorney by the hour.

From a legal client's perspective the difficult economic times makes it all the more important that legal fees do not get out of hand. Hiring an attorney who generally charges well over $100 per hour is a frightening thing. This is especially true when the final cost is uncertain

Professional service providers always face problems with attracting new clients or customers, regardless of whether it is a good or bad economy. Economic recessions only exacerbate this constant problem. This is especially true if the professionals are new to entering the market. In recent years, advertising costs have continued to skyrocket causing marketing to the public for prospective clients to be one of the highest budget items for attorneys. The problem is even more difficult for professionals like attorneys who are under special ethic rules that enforce extraordinarily stringent limits on the manner of advertising in which they can employ, which can be far different from what most other goods or services in the market must comply. For example, many state bar foundations have ethics rules prohibiting lawyers from paying anyone else for referring prospective clients to them. Lawyers face severe punishment, including losing their ability to practice law, for violating these ethics rules. This makes many lawyers understandably highly concerned whenever considering venturing into a new method of advertising to prospective clients. This problem is further exacerbated by new proposed ethics rules currently being considered in some jurisdictions that would even further restrict methods of advertisement—that could potentially force lawyers to stop a practice that is currently widespread of advertising to the public through for profit paid legal referral services. It is important to understand, that pursuant to legal ethics rules, there is a critical distinction between for profit and non profit entities that advertise a lawyer's services. Simply stated, for profit entities are considered a “referral” service, which is ethically prohibited. On the other hand, a qualified non profit legal service is considered a “legal directory”. Therefore, a lawyer is more likely to avoid ethical violation by disseminating information about his or her legal services through a qualified non profit legal directory. In sum, it would be a distinct advantage for lawyers to advertise their services in a manner that is both ethically permissible and less expensive (perhaps free).

Unpaid account receivables is another major problem facing professional service providers. For example, from an attorney's perspective, the compensation received for time spent providing legal services has to fund the entire business including all overhead costs, many of which are fixed. Providing services without a guarantee of payment can significantly increase unpaid accounts receivable and put a law firm out of business. A system or method that decreases or eliminates unpaid account receivables would provide a distinct benefit for professional service providers, such as lawyers.

Presently, existing systems and methods within professional service providers are woefully inadequate. These systems fail in many critical ways, including; not adequately encouraging voluntary compliance of ethical obligations which directly causes a decrease in pro bono services to the poor; not adequately protecting paying clients from being burdened with bills far in excess to what was originally expected; and service providers struggling with mounting advertising costs, bad debt and the like. Considering these separate concerns the problem not only looks insurmountable but the needs of the various parties often seem to be in opposition to each other.

Furthermore, there is currently a gap in the public's ability to find, shop and compare fees of professional service providers. For example, while there are many legal directories, none of them offer what the public wants most—the ability to shop and compare the attorney's fees. There currently does not exist anywhere in the world an ethical, online legal directory that encourages lawyers to list flat rate or fee prices for different services. Therefore, it is impossible for the public to reasonably shop and compare these professional service providers and their fees.

Accordingly, what is needed is a system that solves several critical problems in one combined and simple solution, including: encouragement of professional service providers to voluntarily increase fulfilling their ethical obligations especially to the poor; convenient searching that allows a potential customer to conveniently shop and compare the prices of professional service providers without the hassle of traveling around town and meeting with different providers; and a method of decreasing the cost of attracting potential customers or collecting bad debt.

### DISCLOSURE OF THE INVENTION

The present invention may be readily adapted to searches and/or advertising for providers of a variety of professional services, including legal services. Embodiments of the present invention may provide, among other benefits: a searchable database that reports to the public which service providers are fulfilling certain ethical obligations, allows potential customers to locate service providers in a given location that practice a specific service and which also allows potential customers to compare flat rate prices for the specific service for the located service providers. Additional embodiments of the present invention may provide, among other benefits: a service provider being guaranteed payment; and also provide additional funds for providing services to those who cannot afford them.

One embodiment of the present method provides potential clients with an ethical referral system wherein attorneys list particular services with a flat rate. The referral system sufficiently defines legal categories so that attorneys are able to give a flat rate for their work. This provides the client with certainty relative to the cost of legal representation and enables the client to evaluate whether they can afford the service. Once the client selects an attorney with the related service, the fee payment may be made in full into an IOLTA account. This solves the problem of attorney's bad debt as well as saving much of the money and support services utilized by trying to collect on accounts receivable. Because the attorney only gets paid when the work is concluded the attorney is motivated to complete the task. Further arrangements may also assure a client that the lawyer will not claim payment until the work is done. The advance payment in full that is not distributed until the work is completed will greatly swell the IOLTA accounts for the lawyers in the state and significantly increase the revenue to the bar foundation to aid the poor.

Other embodiments of the invention enable the bar association to use its present system should a dispute arise between the client and the attorney.

In addition, since attorneys have an obligation to provide some services pro bono or in the alternative donate an equivalent amount to the bar association, normally about $500 per year, this invention can dovetail with the pro bono requirement.

In order to help attorneys pay the money necessary to meet their obligation to the bar, the bar association can use the suggested business method in conjunction with Continuing Legal Education and advertising as part of the attorney referral system. For example, a website can be maintained with various attorneys listed for referral purposes. Listings could be ordered giving preference to those attorneys who have met their obligation to the bar association either by donating time or by donating the necessary monetary amount. The attorneys that donate through the listing service may also have the opportunity to participate in ethics offered by the listing service for a fee or just by donating. The listing service would be far less expensive than traditional advertising. Any such advertising would include the flat rate or fee charge for the particular service being requested, as well as indicate if the attorney has fulfilled any charitable obligations.

Once the client selects an attorney they would engage the attorney and pay the fee in full up front either directly to an attorney's IOLTA trust account, the bar association or to a third party trust fund. One embodiment entrusts whoever holds the money with the duty of confirming that the work has been completed prior to releasing the funds to the attorney. Should a dispute arise, the bar association could intervene using their present dispute resolution practices.

A method of advertising practitioners of a specific service, configured according to an embodiment of the present invention, may comprise, a user supplying a location indicator; a user supplying an area of the service; supplying a list of practitioners practicing the area of the service in or near the location indicator; information on whether the professional has fulfilled their ethical obligations; and supplying a flat rate or fee price for each of the practitioners on the list.

A method for locating an attorney, configured according to an alternate embodiment of the present invention, may comprise, supplying a location indicator in which to locate an attorney; supplying an area of law in which to locate an attorney; being supplied a list of attorneys practicing in the area of law in or near the location indicator; and wherein the order of the list is determined by the attorneys' participation in a pro bono program.

A web based system for locating providers of a specific legal service, configured according to an embodiment of the present invention, may comprise, at least one processor; at least one searchable database containing providers of the specific service coupled to the at least one processor; at least one remote processor workably coupled to the at least one processor; a display being coupled to the at least one remote processor; a first prompt being displayed on the display requesting a user to enter a location indicator in which to locate a provider; an input device coupled to the at least one remote processor for receiving the location indicator from the user, wherein the at least one remote processor transmits the location indicator from the user to the at least one processor; a second prompt being displayed on the display requesting the user to enter an area of the specific service that the user is interested in, wherein the input device receives the area of the specific service that the user is interested in and the at least one remote processor transmits the area of the specific service that the user is interested in to the at least one processor; wherein the at least one processor searches the at least one searchable database using the information entered by the user and returns a list containing providers of the specific service in or near the location indicator entered by the user, the area of the specific service the user is interested in, and a flat rate or fee price for the area of the specific service which the user is interested in to the at least one remote processor; and an output device coupled to the at least one remote processor for providing an output of the list returned to the at least one remote processor.

The foregoing and other features and advantages of the invention will be apparent to those of ordinary skill in the art from the following more particular description of the invention and the accompanying drawings.

### BRIEF DESCRIPTION OF THE DRAWINGS

The invention will hereinafter be described in conjunction with the appended drawings where like designations denote like elements, and:

FIG. 1 is a flow chart of a method of advertising practitioners of a specific service configured according to an embodiment of the present invention;

FIG. 2 is a flow chart of a method for locating an attorney configured according to an embodiment of the present invention; and

FIG. 3 is a diagram of a web based system for locating providers of a specific service configured according to an embodiment of the present invention.

### DESCRIPTION OF THE INVENTION

As discussed above, embodiments of the present invention relate to a method and system for searching for a service provider. In particular, a system or method configured according to the present invention effectively allows a user to search for a service provider that provides a specific service close to a specific location and also allows the user to compare flat rate or fee prices for the various service providers returned in the search. Further, the system or method reports to the user whether or not the service provider has made charitable contributions such as completing pro bono work.

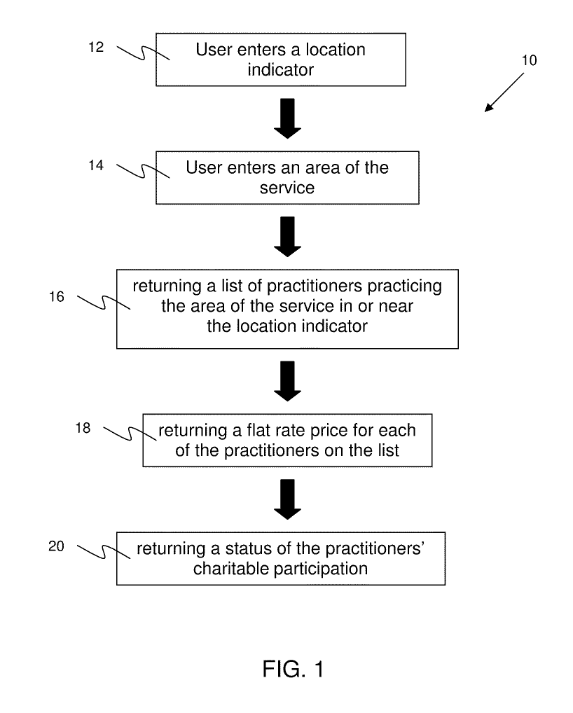

FIG. 1 illustrates a method of advertising practitioners or service providers 10 configured according to an embodiment of the present invention. Practitioners or service providers as referenced above may refer to any one who markets a service, product or the like. Practitioners and service providers include lawyers, attorneys and the like. This method may comprise a user entering or supplying a location indicator 12. Typically the location indicator is entered into a prompt such as a prompt on a webpage, computer program or the like. However, the user may supply, provide, or show the location indicator 12 to another person, an automated phone system, or to any other thing which may use this method in order to advertise practitioners. The user may also simply cross reference the location indicator in a paper form of this invention. A location indicator as referenced above may refer to anything that refers to a specific geographic location. For example, a location indicator may be a zip code, an area code, an address, a city name, a state name, cross streets, a landmark, a longitude and/or latitude, a bearing or the like.

Once the user has entered the location indicator 12, the user may enter the area of the service 14. The area of the service as referenced in 12 is a specific specialty within the overall service. For example, if the user is searching for an attorney, the area of service may be a specialty such as wills and estates or divorce law or the like. The area of service which the user is to enter, provide, supply, show or the like may also be referred to as a specialty, an area of practice, a strength, a long suit, a forte or the like. Similarly to step 12, the area of the service may be entered into a prompt such as on a webpage, a search engine, a computer program or the like. The area of the service may also be provided, supplied or shown to another person, an automated phone system or to any other thing which may use this method in order to advertise practitioners. The user may also simply cross reference the area of the service in a paper form of this invention.

Once the user has completed the steps described in 12 and 14, a list of practitioners who practice the area of the service in or near the location indicated by the location indicator is returned to the user 16. This list may be supplied by a computer program, webpage, a person, automated phone system, and the like or it may be located in a paper form of the present invention.

The list returned in step 16 may contain any information about the practitioners desired. For example, the list may contain the year the practitioner graduated from school, the bars the practitioner has passed if they are an attorney, the schools the practitioner attended, the awards the practitioner has received, how long the practitioner has provided the service, the practitioners exact location, whether or not the practitioner has fulfilled a charitable obligation or participates in a charitable program, whether there have been any complaints against the practitioner or any other information which could be useful in allowing the user to compare the practitioners provided.

In a particular embodiment of the present invention, the list may contain a flat rate or fee price for each of the practitioners 18. A flat rate or fee price is the amount a practitioner will accept for the service provided regardless of the amount of time the practitioner puts into the project. This allows the user to know the exact cost ahead of time rather than being told that they will be billed hourly. Typically this price will be for the specialty which the user entered. For example, if the user is interested in having a will written, the list will contain the flat fee prices for a will. This allows the user to compare price along with the other information provided on the list.

The present invention will further provide detailed descriptions of various types of work to be completed in order to allow the user to find exactly what they want to have the practitioner do. This also allows the practitioner to accurately quote a flat fee for the given work.

As mentioned above, the list may also contain the status of the practitioners' charitable participation 20. For attorneys, in particular, the bar suggests participation in a pro bono program where legal work is provided to those who cannot afford it. This legal work is provided for free. Instead of providing the free legal work themselves, attorneys may donate money which pays for legal work for indigent people. The list may provide information on whether or not the attorneys have fulfilled this pro bono obligation. Other practitioners in other services may also have similar programs that they may participate in. The status of a practitioners' participation in these programs may be provided on the list.

Participation in a pro bono or charitable program by attorneys is encouraged, however there are no consequences for failing to complete pro bono work. Therefore, the majority of attorneys fail to participate in these programs. The present invention creates consequences for failing to participate in pro bono or charitable programs, by reporting this failure to users who are looking for attorneys to do their work. Users are able to view whether or not the attorney has completed their charitable obligation and may determine not to hire an attorney who has not participated in charitable work. The same would be true for practitioners in other areas of service.

The status of a practitioners' participation in charitable programs may be returned as a numerical ranking, a percentage, or words such as completed, not completed, partially completed or the like. Status may be reported for one year or for multiple years. Participation in pro bono or charitable programs may be self reported by the practitioners or may be regulated by a governing organization, a third party, the operators of the system or the like.

The status of the practitioners' charitable participation may also be used to determine the order of the list. Practitioners who have fulfilled their charitable obligation would be given priority placement on the list, while those who have not fulfilled their obligation would be moved to the bottom of the list. This would encourage practitioners to fulfill their charitable obligations/suggestions. Additionally, practitioners who have fulfilled their charitable obligation could be listed in bigger font, colored font, have more detailed information provided, better ratings or the like.

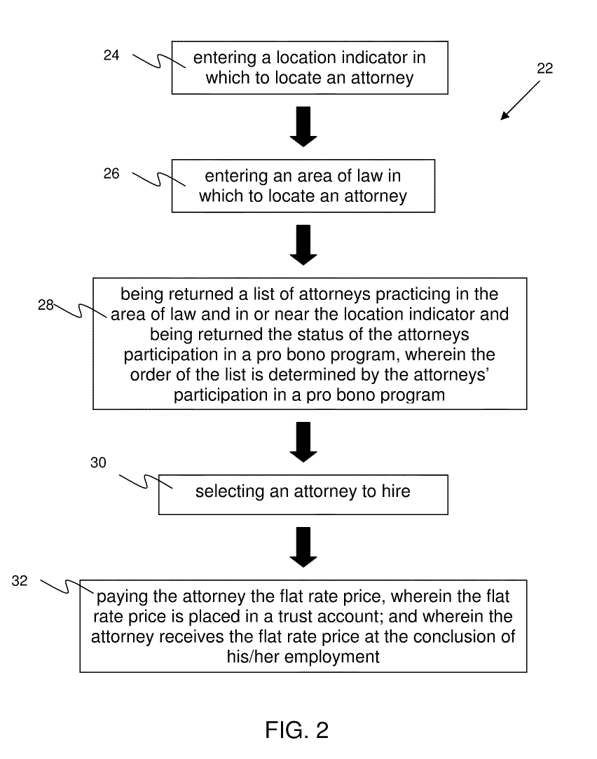

FIG. 2 illustrates a method for locating an attorney 22. The method may be used to locate any type of service provider or practitioner.

In order to locate an attorney using this method, the user enters a location indicator at or near which to locate an attorney 24. Typically the location indicator is entered into a prompt such as a prompt on a webpage, computer program or the like. However, the user may supply, provide, or show the location indicator 12 to another person, an automated phone system, or to any other thing which may use this method in order to advertise practitioners. The user may also simply cross reference the location indicator in a paper form of this invention. A location indicator as referenced above may refer to anything that refers to a specific geographic location. For example, a location indicator may be a zip code, an area code, an address, a city name, a state name, cross streets, a landmark, a longitude and/or latitude, a bearing or the like.

Next, the user enters an area of law in which to locate an attorney 26. The area of law as referenced in 26 is a specific specialty within the overall practice of law. For example, the area of law may be real estate, intellectual property, wills and trusts, estate planning, divorce, litigation, contracts, election law, tax law, negotiations, business law or any other specialty or specific service that might be offered. The area of law which the user is to enter, provide, supply, show or the like may also be referred to as a specialty, an area of practice, a strength, a long suit, a forte or the like. Similar to step 24, the area of law may be entered into a prompt such as on a webpage, a search engine, a computer program or the like. The area of law may also be provided, supplied or shown to another person, an automated phone system or to any other thing which may use this method in order to locate attorneys. The user may also simply cross reference the area of law in a paper form of this invention.

The user is then returned a list of attorneys practicing in the area of law and in or near the location indicator. The user is also returned the status of the attorneys' participation in a pro bono program, wherein the order of the list is determined by the attorneys' participation in a pro bono program 28. For attorneys, in particular, the bar suggests participation in a pro bono program where legal work is provided to those who cannot afford it. This legal work is provided for free. Instead of providing the free legal work themselves, attorneys may donate money which pays for legal work for indigent people. The list may provide information on whether or not the attorneys have fulfilled this pro bono obligation. Other practitioners in other services may also have similar programs. The status of a practitioners' participation in these programs may be provided on the list.

The status of a practitioners' participation in charitable programs may be returned as a numerical ranking, a percentage, or words such as completed, not completed, partially completed or the like. Status may be reported for one year or for multiple years. Participation in pro bono or charitable programs may be self reported by the practitioners or may be regulated by a governing organization, a third party, the operators of the system or the like.

Participation in a pro bono or charitable program by attorneys is encouraged, however there are no consequences for failing to complete pro bono work. Therefore, the majority of attorneys fail to participate in these programs. The present invention creates consequences for failing to participate in pro bono or charitable programs, by reporting this failure to users who are looking for attorneys to do their work. Users are able to view whether or not the attorney has completed their charitable obligation and may determine not to hire an attorney who has not participated in charitable work. The same would be true for practitioners in other areas of service.

The status of the attorneys' pro bono participation may also be used to determine the order of the list. Attorneys who have fulfilled their pro bono obligation would be given priority placement on the list, while those who have not fulfilled their obligation would be moved to the bottom of the list. This would encourage attorneys to fulfill their pro bono obligation/suggestion. Additionally, practitioners who have fulfilled their charitable obligation could be listed in bigger font, colored font, have more detailed information provided, better ratings or the like.

The list returned in step 28 may contain any information about the attorneys desired. For example, the list may contain the year the attorneys graduated from school, the bars the attorneys have passed, the schools the attorneys attended, the awards the attorneys have received, how long the attorneys have practiced, major cases the attorneys have participated in, the attorneys exact location, whether there have been any complaints against the attorneys or any other information which could be useful in allowing the user to compare the attorneys provided.

In a particular embodiment of the present invention, the list may contain a flat rate or fee price for each of the attorneys. A flat rate or fee price is the amount an attorney will accept for the service provided regardless of the amount of time the attorney puts into the project. This allows the user to know the exact cost ahead of time rather than being told that they will be billed hourly. Typically this price will be for the specialty which the user entered. For example, if the user is interested in having a will written, the list will contain the flat rate pr fee prices for a will. This allows the user to compare price along with the other information provided on the list.

The present invention will further provide detailed descriptions of various types of work to be completed in order to allow the user to find exactly what they want to have the practitioner do. This also allows the practitioner to accurately quote a flat fee for the given work.

Next, the user may select an attorney to hire 30. Once this is complete, the user pays the attorney the flat rate or fee price listed on the list 32. The money is placed in a trust account and the attorney only receives payment for the service at the conclusion of his or her employment 32. This provides comfort to the user in that the attorney is not paid until they have actually completed the work. This method of payment also provides security for the attorney, because they know they will be paid at the conclusion of the work instead of having to bill the client and hope that they pay. Interest earned on the money in the trust account is used for a charitable purpose such as funding pro bono legal work.

Should a dispute arise between the client and the attorney, the bar's standard dispute resolution could be used.

In order for a service provider to be included on the lists returned in the above two methods, the service provider must first agree to take a flat rate or fee and to be bound to the flat rate or fee quoted on the list. The service provider must also agree to be paid at the conclusion of their work. Additionally, in alternate embodiments, it may be desirable to require the service provider to take a continuing education class concerning the methods described above or concerning ethical obligations. This class could be provided by the entity operating the methods and fees from the classes could be used for charitable purposes.

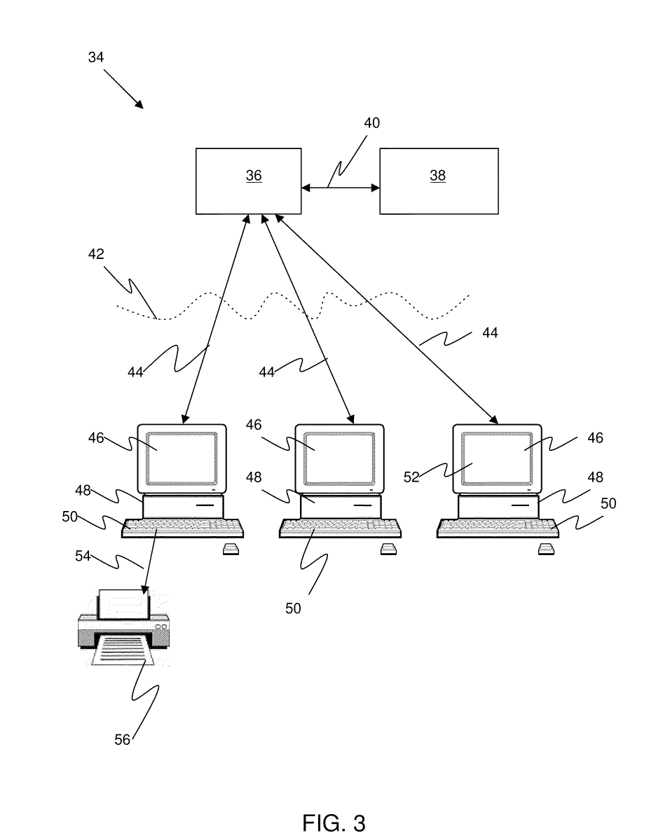

FIG. 3 illustrates a diagram of a web based system 34 for locating providers of a specific service configured according to an embodiment of the present invention. A web based system 34 configured according to an embodiment of the present invention may comprise a processor 36. This processor 36 may be a PC, MAC, CPU, Mainframe, computer or any other device that can serve the purposes of this invention. The processor 36 is operably or workably coupled or connected 40 to at least one database 38.

The workable coupling or connection 40 may be hardwired, a cable, wireless, the processor's ability to read a disk or its disk drive, or any other device by which the processor gains access to the information stored in the database 38. The connection 40 is illustrated with an arrow at each end in order to show that information is sent from the database 38 to the processor 36 and requests for information are sent from the processor 36 to the database 38. Therefore, information travels both ways through the connection 40.

The database 38 may be any device that stores information, including but not limited RAM, CD, DVD, Flash Media, a hard drive or the like. The database 38 may contain a list of service providers that may be accessed by the processor 36.

The processor 36 is operably/workably coupled or connected 44 to at least one remote processor 48. This operable/workable coupling or connection 44 may be any connection that allows information or requests for information to travel in two directions as illustrated by the arrows on the illustration of the connection 44. This connection 44 may use cable or be wireless. Typically, however, it will be over the internet as illustrated by 42. The internet 42 is any electronic communications network that connects computer networks and organizational computer facilities around the world.

The at least one remote processor 48 may be a PC, MAC, CPU, Mainframe, computer or any other device that can serve the purposes of this invention. Typically, however, it will simply be a home computer or laptop.

The at least one remote processor 48 is coupled or connected to a display 46 such as a computer screen or the like. The at least one remote processor 48 is also coupled or connected to an input device 50 such as a keyboard, microphone, mouse, touchscreen or other device that allows a user to input information into the at least one remote processor 48. An output device 56 such as a computer screen, a printer, a burner or any other device that provides information to the user may also be coupled to the at least one remote processor. If the output device 56 is a printer or other device that is not typically a part of a computer, then the output device 56 may be workably/operably coupled or connected 54 to the at least one remote processor 48 by cable, wireless, internet or any other type of connection that serves to transmit information from the at least one remote processor 48 to the output device 56.

When the above described web based system 34, is operating as an embodiment of the present invention, a prompt will be displayed on the display 46 which asks the user to enter a location indicator. The user enters a location indicator (as described in previous embodiments) into the at least one remote processor 48 through the input device 50. The location indicator may be entered into a box that requires the user to type in the indicator or it may be selected from a pull down menu or the like. The user then enters the area of the service or of law that the user is interested in. The user enters the area of the service or of the law (as described in previous embodiments) into the at least one remote processor 48 through the input device 50. The area may be entered into a box that requires the user to type in the indicator or it may be selected from a pull down menu or the like.

The area of the service or the law that the user is interested in and the location indicator travel through the coupling 44 to the processor 36. The processor 36 then searches the database 38 using the location indicator and the area of the service or of law as criteria. The processor 36 compiles a list of service providers that meet the criteria provided by the user.

The processor 36 then reviews other criteria such as whether or not the service providers have completed charitable participation in order to determine the order in which the service providers will be placed on the list provided to the user. The processor 36 then sends a list containing information about the service providers to the at least one remote processor 48 which the user is operating.

The list returned to the user is then sent to the output device 56 in order to allow the user to have access to it. The list either appears on the screen of the computer the user is operating or is printed to a printer connected to the computer or the like.

The user may then proceed to hire a service provider on the list. As in the methods described above, the service providers included in the list have agreed to be paid at the conclusion of the work. Therefore, the user pays the flat fee upfront and the money is placed in an account. The interest from the account goes to charitable programs. The attorney is paid once the project has been completed.

In alternate embodiments to the present invention, the service providers may be required to take a continuing education class such as a continuing legal education class which could be provided through the web based system 34 described above. The continuing education class would be accessible by the user through a remote processor 48 which would access the class on the processor 36. Completion of the continuing education class could be required on a yearly basis or other time period in order to certify the service providers to be included on the lists returned by the web based system 34. Any fees from the continuing education class could be used to fund charitable programs.

In additional alternate embodiments of the present invention, a system or method may allow a user to search for a variety of different service providers. In this situation, the user would select an overall service and then select a specialty within that service. For example, a web based system configured according to this embodiment would allow a user to search for attorneys on the same site.

Alternate embodiments of the present invention may also allow service providers to submit bids for individual work projects.

Other embodiments of the present invention may comprise a catalog of service providers with a means of cross referencing a location indicator and an area of the service in order to find a list of service providers.

The embodiments and examples set forth herein were presented in order to best explain the present invention and its practical applications and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. Accordingly, any components of the present invention indicated in the drawings or herein are given as an example of possible components and not as a limitation.

1. A method of advertising practitioners of a specific service comprising:
a user supplying a location indicator;
a user supplying an area of the service;
supplying a list of practitioners practicing the area of the service in or near the location indicator;
supplying a status of charitable participation for each of the practitioners on the list; and
supplying a flat rate or fee price for each of the practitioners on the list.

2. The method of claim 1, wherein the specific service is legal practice.

3. The method of claim 1, wherein the practitioners agree to be paid after providing a service.

4. The method of claim 3, wherein the agreement is required in order for the practitioner to be included in the list.

5. The method of claim 3, wherein the user agrees to pay for the service prior to the service being provided.

6. The method of claim 1, further comprising supplying a status of the practitioners' charitable participation.

7. The method of claim 6, wherein charitable participation improves the practitioner's position on the list.

8. The method of claim 1, wherein participation in an educational program is required in order for a practitioner to be listed on the list.

9. A method for locating an attorney comprising:
supplying a location indicator in which to locate an attorney;
supplying an area of law in which to locate an attorney;
being supplied a list of attorneys practicing in the area of law and in or near the location indicator;
being supplied each of the attorneys' status of participation in a pro bono program; and
wherein the order of the list is determined by the attorneys' participation in a pro bono program.

10. The method of claim 9, wherein the list of attorneys further comprises the attorneys' flat rate or fee price.

11. The method of claim 9, further comprising:
selecting an attorney to hire;
paying the attorney the flat rate or fee price, wherein the flat rate or fee price is placed in a trust account;
further comprising the attorney receiving the flat rate or fee price at the conclusion of his/her employment.

12. The method of claim 11, wherein any interest earned by the trust account is used for charitable services.

13. The method of claim 9, wherein participation in a continuing legal education class may be required in order for an attorney to be included on the list of attorneys.

14. A web based system for locating providers of a specific service, the system comprising:
at least one processor;
at least one searchable database containing providers of the specific service coupled to the at least one processor;
at least one remote processor workably coupled to the at least one processor;
a display being coupled to the at least one remote processor;
a first prompt being displayed on the display requesting a user to enter a location indicator in which to locate a provider;
an input device coupled to the at least one remote processor for receiving the location indicator from the user, wherein the at least one remote processor transmits the location indicator from the user to the at least one processor;
a second prompt being displayed on the display requesting the user to enter an area of the specific service that the user is interested in, wherein the input device receives the area of the specific service that the user is interested in and the at least one remote processor transmits the area of the specific service that the user is interested in to the at least one processor;
wherein the at least one processor searches the at least one searchable database using the information entered by the user and returns a list containing providers of the specific service in or near the location indicator entered by the user, the area of the specific service the user is interested in, the status of the providers' participation in a charitable program, and a flat rate or fee price for the area of the specific service which the user is interested in to the at least one remote processor; and
an output device coupled to the at least one remote processor for providing an output of the list returned to the at least one remote processor.

15. The system of claim 14, wherein the at least one processor determines the order of the list according to which providers have participated in charitable programs.

16. The system of claim 14, wherein in order to be included on the list a provider must agree to be paid at the conclusion of the service.

17. The system of claim 16, wherein if the user decides to use one of the providers on the list, the user must pay for the service before the service has been begun and the money is placed in an account and held until the provider has completed the service at which time the provider is paid.

18. The system of claim 17, wherein any interested earned on the account is used to fund charitable programs.

19. The system of claim 14, wherein the at least one remote processor may access a class on the at least one processor which any provider who wants to be included in the list must complete.

20. The system of claim 14, wherein the specific service is the legal service.
